(19) United States
(12) Patent Application Publication
(10) Pub. No.: US 2010/0206993 A1
(43) Pub. Date: Aug. 19, 2010

(54) STEERING STRUCTURE OF TOY PLANE AND INFRARED FOUR-CHANNEL REMOTE-CONTROL ELECTRIC TOY PLANE

(75) Inventor: Wen Li, Xi'an City (CN)

Correspondence Address: HARRIS BEACH PLLC, 99 GARNSEY ROAD, PITTSFORD, NY, 14534, US

(73) Assignee: Wenjie Xu, Hong Kong (CN)

(21) Appl. No.: 12/689,323

(22) Filed: Jan. 19, 2010

(30) Foreign Application Priority Data
Jan. 19, 2009 (CN) 200910000856.8

(51) Int. Cl. B64C 13/34; G05D 1/00

(52) U.S. Cl. 244/231; 701/3

(57) ABSTRACT

This invention discloses a steering structure of toy plane and an infrared four-channel remote-control electric toy plane. The steering structure of toy plane includes small internal guide, large external guide, elliptical shaft, and sector gear; the small internal guide has a rectangle hole with rounded angles and two arc-back bosses, and driven by the sector gear, the small internal guide contacts the elliptical shaft along the second and fourth quadrants; the large external guide has the elliptical hole, and driven by the sector gear, the large external guide contacts the elliptical shaft along first and third quadrants. The small infrared four-channel remote-control plane has adopted such steering structure, which allows the small internal guide or the large external guide to change the rotating direction of lower propeller by contacting the elliptical shaft, so as to realize the simple steering structure, also large reduction on product cost, and the functions of Forward/Backward and Left Turn/Right Turn of mini toy plane.

### TECHNICAL FIELD

This invention involves a steering structure for toy plane. To be specific, it is a type of steering structure used on the toy plane with upper and lower propeller units. In addition, this invention also involves the infrared four-channel remote-control electric toy plane that uses such steering structure to realize the functions of Ascending/Descending, Forward/Backward, Left Turn/Right Turn, and Tail Left Turn/Tail Right Turn.

### BACKGROUND ART

Now there is a toy steering engine on the market that can realize the functions of Ascending/Descending, Forward/Backward, Left Turn/Right Turn, and Tail Left Turn/Tail Right Turn. For realizing the functions of Forward/Backward and Left Turn/Right Turn, such steering engine adopts the special IC control with weight as high as 6 g. In addition, the structure of this steering engine is complex, and the control precision is high and only applicable to the professional models, so it is hard for generalization of such steering engine because of the high cost.

The electric toy helicopter with Chinese Patent No.: CN2759542 is composed of plane body and remote control. Said plane body includes two groups of propeller unit, body and landing gears, of which, the propeller units are located above plane body and connected with it, and the landing gears are located below the plane body and connected with it for supporting the propeller units and the plane body. Said propeller units include upper propeller, lower propeller, hollow shaft, steering mechanism and small main shaft. Of which, said hollow shaft is inserted in till middle section of said hollow shaft, the cuff of said upper propeller is connected with said plane body, said steering mechanism connects the end of middle section of said hollow shaft, the cuff of said lower propeller is positioned at middle section of said hollow shaft, the cuff of said upper propeller is positioned at upper section of said hollow shaft, and in addition, the sleeve of small main shaft is positioned beyond hollow shaft and is connected with upper propeller. The above electric toy helicopter can realize the balanced take off, and be controlled flexibly and freely. However, the steering mechanism of such electric toy helicopter is more complex and more expensive.

### BRIEF SUMMARY OF THE INVENTION

The aim of this invention is to provide a steering mechanism with simple structure of toy plane, and solve the problem of complex structure of steering engine for realizing Forward/Backward and Left Turn and Right Turn.

The other aim of this invention is to provide a type of infrared four-channel remote-control electric toy plane that uses this steering structure to realize Ascending/Descending, Forward/Backward, Left Turn/Right Turn, and Tail Left Turn/Tail Right Turn.

The technical scheme of this invention for solving such problem is:

The steering structure of toy plane includes small internal guide, large external guide, elliptical shaft and sector gear; the small internal guide has a rectangle hole with rounded angles and arc-back bosses, and driven by the sector gear, the small internal guide contacts the elliptical shaft along the second and fourth quadrants; the large external guide has the elliptical hole, and driven by the sector gear, the large external guide contacts the elliptical shaft along first and third quadrants.

The contact angle of said small internal guide along the second and fourth quadrants connects with elliptical shaft is 135°.

The contact angle of said large external guide along the first and third quadrants connects with elliptical shaft is 45°.

Said small internal guide shows a crooked pattern and has three rectangular slots and two arc-back bosses, and the arc-back bosses are configured on the edge of rectangle hole, of which the rectangular slot on the crooked end is fixed on pin of sector gear, and other two rectangular slots are fixed on diagonal pins on upper carriage. The large external guide also shows the crook pattern and has three rectangular slots and annular raised structure with elliptical hole on the top, the side has two diagonal arc openings, and the small internal guide goes through these two arc openings and is assembled with the large external guide in a cross way, of which the rectangular slot on the crooked end is placed on the raised pin of the second sector gear, and the other two rectangular slots are placed on the two remaining diagonal pins on the upper carriage.

Said small internal guide goes through two arc openings and is assembled with the large external guide in a cross way by 45°, and the movement closed angle of the two is 90°.

Said elliptical shaft has the square upper end and has the groove for facilitating the elliptical shaft to adjust the rotating angle of lower propeller, the middle part is in column shape, the lower end is elliptical, the lower part is positioned in the hole between arc-back bosses of small internal guide, and the middle part is positioned in the elliptical hole of large external guide; rectangle hole with rounded angles, elliptical hole and elliptical shaft are on the joint axis, and the upper end of elliptical shaft is fixed on the mounting structure of lower propeller.

Small infrared four-channel remote-control plane is composed of nose covering, landing gears, propeller carriage, tail rod, empennage, upper and lower propeller units, drive mechanism for upper and lower propellers installed on the propeller carriage, control system for controlling motor running, and steering structure. Such steering structure contains small internal guide, large external guide, elliptical shaft, and sector gear; the small internal guide has the rectangle hole with rounded angles and the arc-back bosses, and the small internal guide contacts with the elliptical shaft along the second and fourth quadrants under the driving of sector gear; the large external guide has the elliptical hole, and the large external guide contacts with the elliptical shaft along the first and third quadrants under the driving of sector gear.

The beneficial effect of this invention: It can change the rotation angle of lower propeller only by contact of small internal guide or large external guide to simplify the structure of steering mechanism and greatly reduce the product cost, and it allows the mini toy plane to realize the functions of Forward/Backward and Left Turn/Right Turn.

### BRIEF DESCRIPTION OF THE DRAWINGS

FIG. 1: Schematic figure of spatial structure of preferred embodiment;

FIG. 2: Schematic figure of combined spatial structure of propeller carriage, upper and lower propellers, drive mechanism for propellers, and steering mechanism;

FIG. 3: Schematic figure of exploded assembly of FIG. 1;

FIG. 4: Schematic figure of upper carriage;

FIG. 5: Schematic figure of lower carriage;

FIG. 6: Schematic figure of structure of sector gear;

FIG. 7: Schematic figure of structure of large external guide;

FIG. 8: Schematic figure of structure of small internal guide;

FIG. 9: Schematic figure of structure of elliptical shaft;

FIG. 10: Action schematic figure of actuating flying function of left turn and right turn;

FIG. 11: Action schematic figure of actuating function of flying forward and backward;

In the figures:
1. Nose covering;
2. Landing gears;
3. Propeller carriage;
31. Upper carriage;
311. Large through hole;
312. Pin hole;
313. Through hole;
314. Boss;
315. Balance bar;
32. Lower carriage;
321. Motor hole;
4. Tail rod;
5. Empennage;
6. Upper propeller unit;
61. Small main shaft;
62. Upper propeller;
7. Lower propeller unit;
71. Hollow shaft;
72. Lower propeller;
8. Drive mechanism for upper and lower propellers;
81. Driven wheel;
9. Steering mechanism;
91. Small internal guide;
911. Rectangle hole with rounded angles;
912. Arc-back boss;
913. Rectangular slot;
92. Large external guide;
921. Annular raised structure;
922. Elliptical hole;
923. Arc opening;
93. Elliptical shaft;
94. Sector gear;
10. Main motor;
101. Motor gear;
11. Small motor.

### DETAILED DESCRIPTION OF THE INVENTION

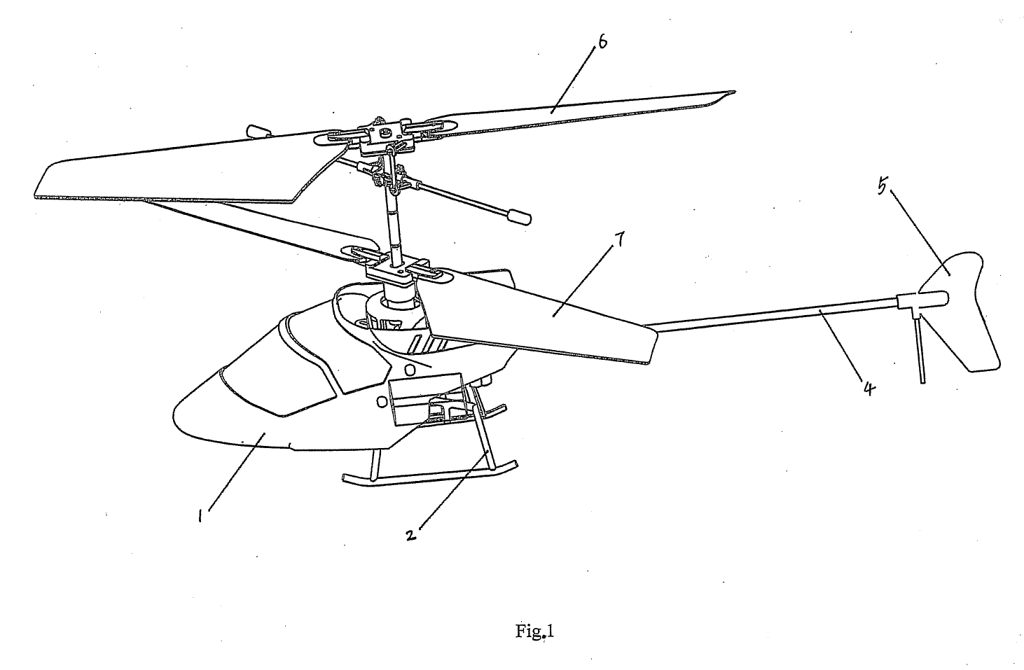

As shown from FIG. 1 to FIG. 3, this embodiment includes nose covering (1), landing gears (2), propeller carriage (3), tail rod (4), empennage (5), upper propeller unit (6), lower propeller unit (7), drive mechanism for upper and lower propeller (8) installed on propeller carriage (3), at least one steering mechanism (9), and the MCU program control system for controlling motor running (not shown on the figure), and the concrete optional parts and installation parts refer to the electric toy helicopter in Chinese Patent No. ZL200720055016.8.

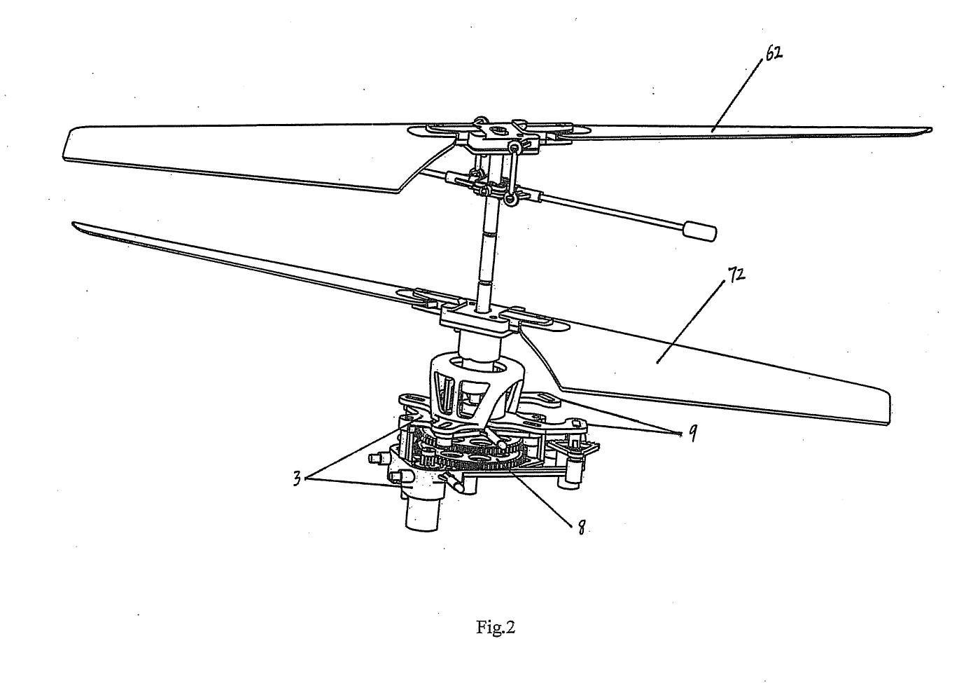

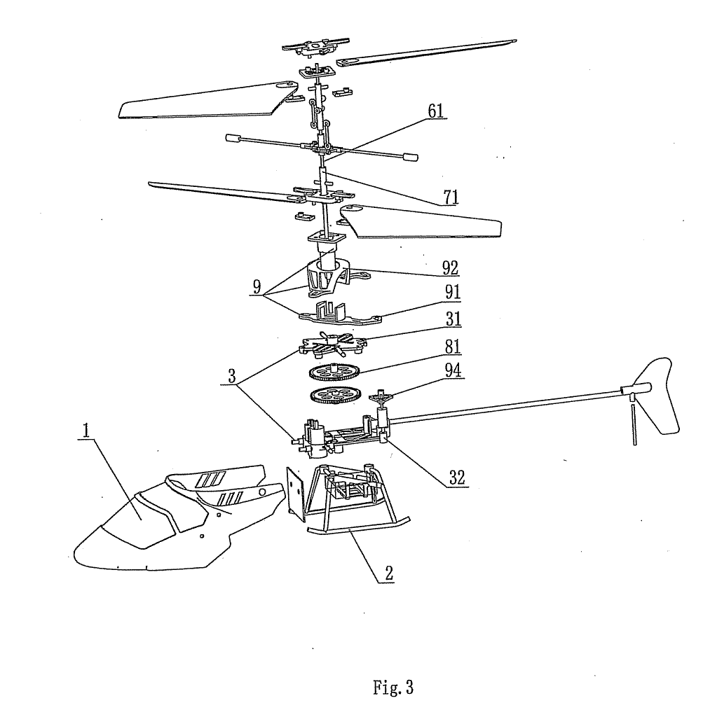

As shown from FIG. 2 to FIG. 3, the upper propeller unit (6) mainly includes small main shaft (61), and a pair of upper propellers (62); the lower propeller unit (7) mainly includes hollow shaft (71), and a pair of lower propellers (72); the installation of small main shaft (61) or hollow shaft (71) with propeller can refer to the prior art, which hollow shaft (71) goes through small main shaft (61) and is fixed in the bore of driven wheel (81) of drive mechanism of lower propeller, while small main shaft (61) is fixed in the bore of driven wheel (81) of drive mechanism of upper propeller; as the outer diameter of hollow shaft (71) is larger than the outer diameter of small main shaft (61) and the length is shorter than small main shaft (61), so when the drive mechanism (8) for propellers drives the upper and lower propeller units, the movements of upper and lower propellers are not interfering. The specific selection of other unit parts on propeller units and installation between the parts can refer to the prior art.

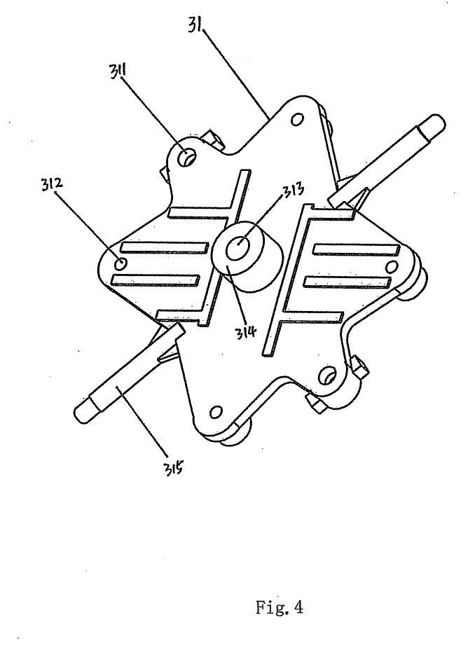

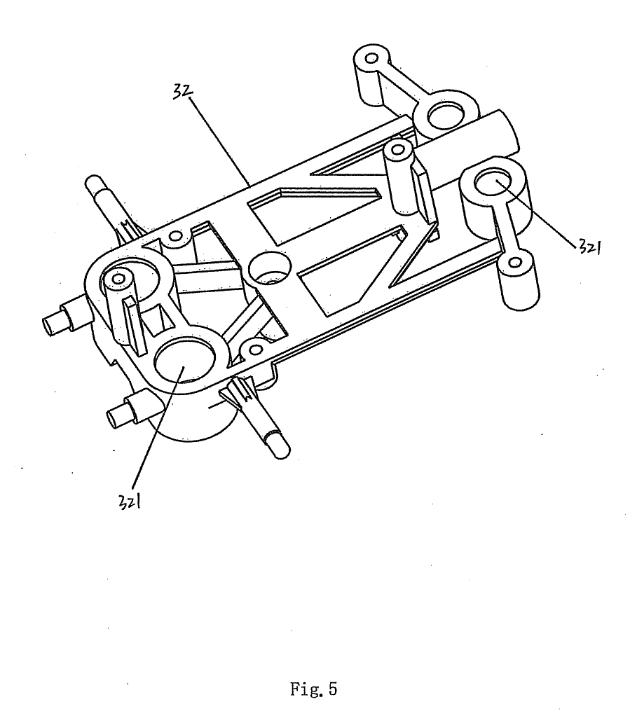

As shown from FIG. 2 to FIG. 5, the propeller carriage (3) includes upper carriage (31) and lower carriage (32); upper carriage (31) is in hexagon, the large through holes (311) are bored on two diagonal positions at front and back of upper carriage (31) relative to the direction of nose covering (1), and screws or pins are put through such two through holes (311) and two through holes on lower carriage (32) to fix upper carriage (31) and lower carriage (32) together; the other four corners of upper carriage (31) are bored with pin hole, and pins are hammered into pin holes for fixing small internal guide (91); The right center of upper carriage (31) has a boss (314) with bore (313), such bore (313) is used for inserting small main shaft (61) and hollow shaft (71) driving upper and lower propellers, and such boss (314) is used for holding rectangle hole with rounded corners (911) of small internal guide (91); in addition, the side of upper carriage (31) is installed two balance bars (315), and the centers of two balance bars (315) are on the same line; relative to the direction of nose covering (1), the motor holes (321) are bored on front and back ends of lower carriage (32) for placing motor, the two motor holes (321) at front are for placing main motor (10), the two motor holes (321) at back are for placing small motor (11), the main motor (10) is for driving drive mechanism for upper and lower propellers (8), and the small motor (11) is for driving sector gear (94) connected with small internal guide (12) or large external guide (92).

As shown from FIG. 2 to FIG. 3, the drive mechanism for upper and lower propellers (8) includes two main motors (10) and two driving and driven gear sets, main motor (10) drives motor gear on its rotating axis (101), then drives driven wheel (81) engaged with it, since hollow shaft (71) or small main shaft (61) is fixed in the bore of driven wheel (81), thus main motor (10) can drive hollow shaft (71) or small main shaft (61) to rotate, and therefore drives upper propeller (62) and upper propeller (72) to rotate.

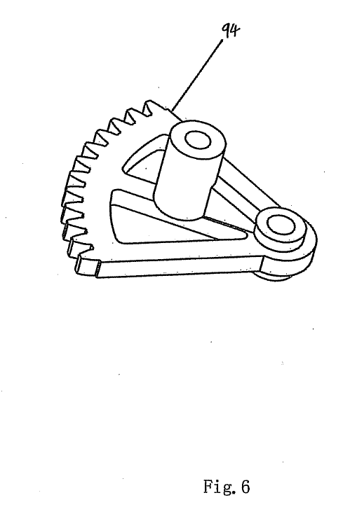

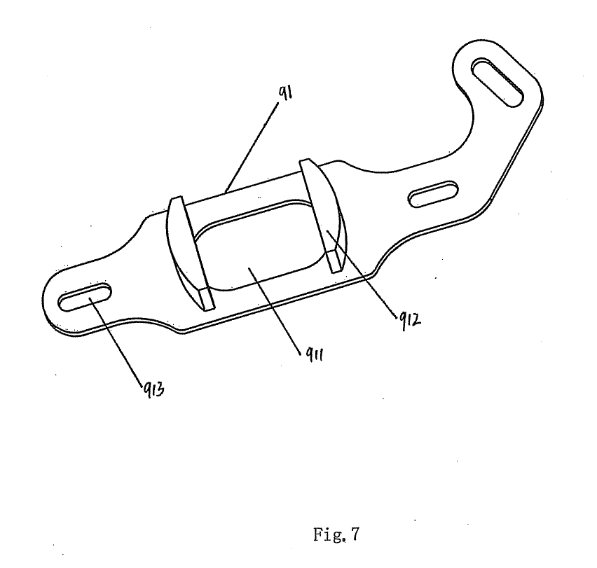

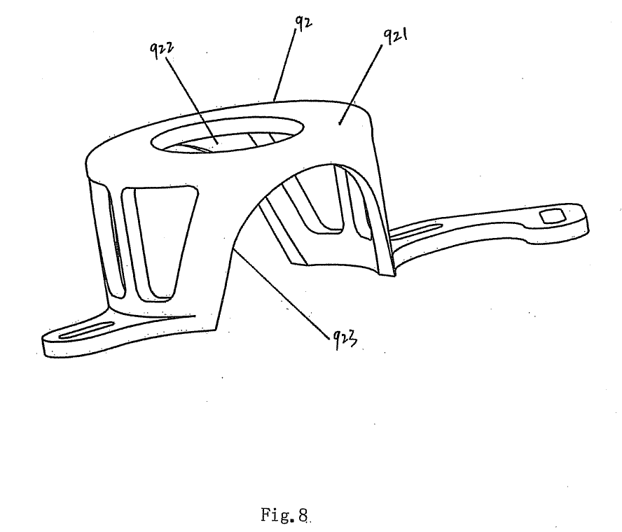

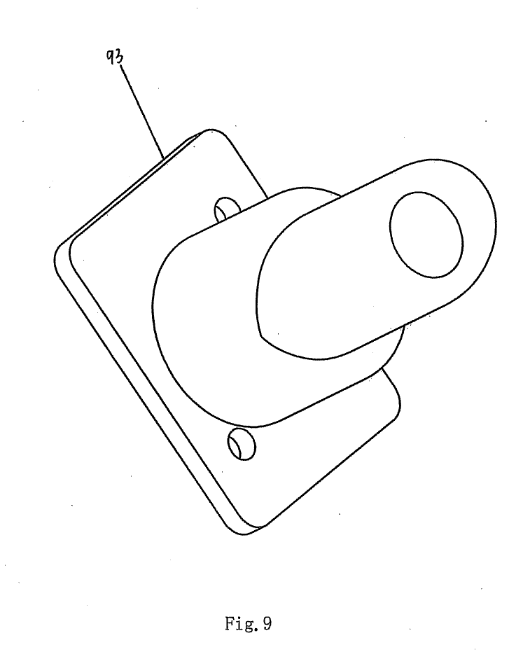

As shown from FIG. 1 to FIG. 3 and from FIG. 6 to FIG. 11, the steering mechanism (9) includes two sector gears (94), one large external guide (92), one small internal guide (91) and one elliptical shaft (93), and large external guide (92), small internal guide (91), and elliptical shaft (93) are arranged in the sequence of elliptical shaft (93), large external guide (92) and small internal guide (91) from top to bottom; sector gear (94) is placed at the back of lower carriage (32), and is engaged with motor gear (101) on small motor (11). Such sector gear (94) has a boss, the boss has the pin hole, pin is hammered in such pin hole, and such pin is used for driving movement of small internal guide (91) or large external guide (91) when sector gear (94) moves; small internal guide (91) shows the crooked pattern and has three rectangular slots (913) and two arc-back bosses (912), it is rectangle hole with rounded angles (911) between two arc-back bosses (912), of which the rectangular slot (913) at the crooked end is put onto the pin on sector gear (94), and other two rectangular slots (911) are put onto the diagonal pins on upper carriage (31), and rectangle hole with rounded angles is put on boss (314) with through hole (313) in the center of upper carriage (31); large external guide (92) also shows the crooked pattern and has three rectangular slots (913) and annular raised structure (921), such annular raised structure (921) has the elliptical hole (922) inside, the side has two diagonal arc openings (923), small internal guide (91) goes through such two arc openings (923) and is assembled with large external guide (92) in a cross way, the assembly is performed as per 45° by optimization, and movement closed angle of the two is 90°, of which the rectangular slot (913) at crooked end is put onto the raised pin of the second sector gear (94), and the other two rectangular slots (913) are put onto the remaining two diagonal pins on upper carriage (31); the elliptical shaft (93) has the square upper end and has the groove for facilitating the elliptical shaft (93) to adjust the rotating angle of lower propeller unit (6), the middle part is in column shape, the lower end is elliptical, the lower part is positioned in the hole between arc-back bosses (912) of small internal guide (91), and the middle part is positioned in the elliptical hole (922) of large external guide (92); rectangle hole with rounded angles (911), elliptical hole (922) and elliptical shaft (93) are on the joint axis, and the upper end of elliptical shaft (93) is fixed on the mounting structure of lower propeller.

In this embodiment, the upper propeller is the main driving propeller, the balance bars in the middle is for balance of plane, and the lower propeller is the control propeller to control the plane to realize the functions of Forward/Backward and Left Turn/Right Turn. When upper and lower propellers keep the uniform speed of rotation, the plane ascends when the main motor (10) accelerates, and the plane descends when the main motor (10) decelerates. The differential drive of two propellers realizes the function of Tail Left Turn/Tail Right Turn.

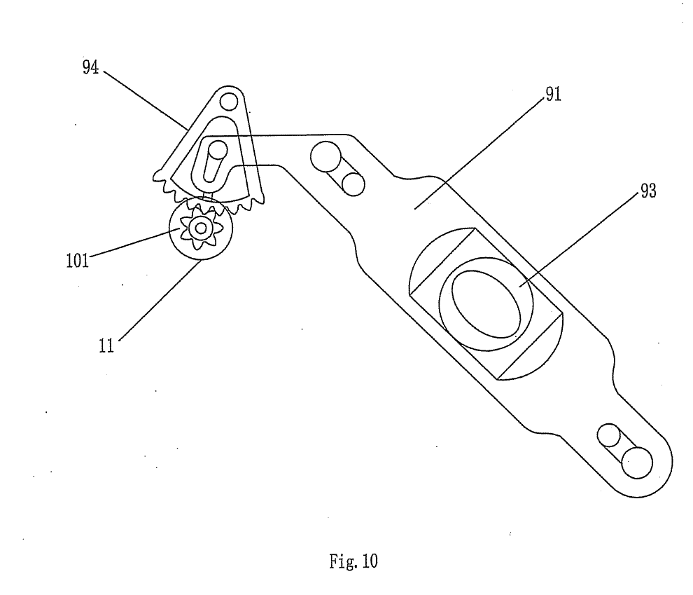

As shown in FIG. 10, for realizing the flying function of Left Turn/Right Turn in this embodiment, MCU program control system drives small motor (11), small motor (11) then drives sector gear (94) through motor gear (101) on it, pin on raised part on sector gear (94) drives small internal guide (91) to move towards the direction of sector gear (94) to allow small internal gear (91) to go along the second and fourth quadrants to contact elliptical shaft (93) by 135°, and therefore change the left and right elevation of rotation of lower propeller and realize the flying function of Left Turn/Right Turn of small plane.

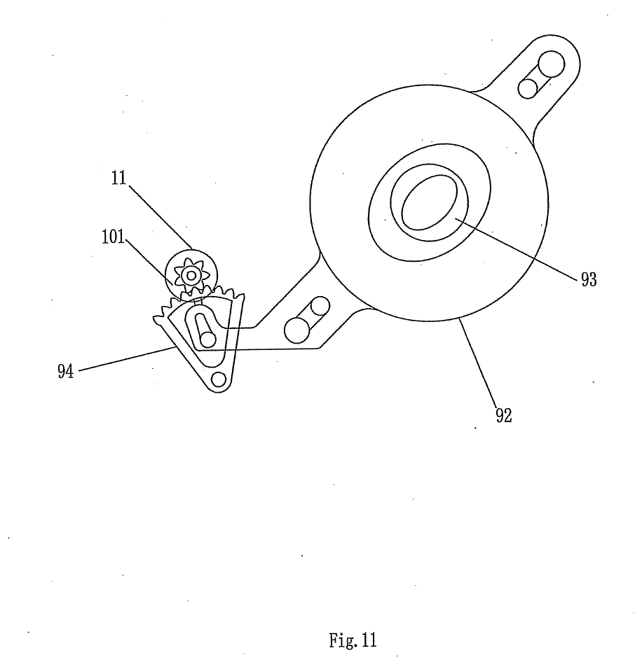

As shown in FIG. 11, for realizing the flying function of Forward/Backward in this embodiment, MCU program control system drives small motor (11), small motor (11) then drives sector gear (94) through motor gear (101) on it, pin on raised part on sector gear (94) drives large external guide (92) to move towards the direction of sector gear (94) to allow large external gear (92) to go along the first and third quadrants to contact elliptical shaft (93) by 45°, and therefore change the front and back elevation of rotation of lower propeller and realize the flying function of Forward/Backward.

The above describes the principle of this invention through detailed description of embodiments. It is evident that the ordinary technicians in this field may, under the guidance of above guidance, perform various improvements, transformations and equivalent replacement without departing from the scope of protection of this invention.

1. The characteristics of steering structure of toy plane: It includes small internal guide, large external guide, elliptical shaft and sector gear; the small internal guide has a rectangle hole with rounded angles and arc-back bosses, and driven by the sector gear, the small internal guide contacts the elliptical shaft along the second and fourth quadrants; the large external guide has the elliptical hole, and driven by the sector gear, the large external guide contacts the elliptical shaft along first and third quadrants.

2. The characteristics of steering structure of toy plane according to the claim 1: The contact angle of said small internal guide along the second and fourth quadrants contacts with elliptical shaft is 135°.

3. The characteristics of steering structure of toy plane according to the claim 1: The contact angle of said large external guide along the first and third quadrants contacts with elliptical shaft is 45°.

4. The characteristics of steering structure of toy plane according to the claim 1: Said small internal guide shows a crooked pattern and has three rectangular slots and two arc-back bosses, and the arc-back bosses are configured on the edge of rectangle hole, of which the rectangular slot on the crooked end is fixed on pin of sector gear, and other two rectangular slots are fixed on diagonal pins on upper carriage. The large external guide also shows the crook pattern and has three rectangular slots and annular raised structure with an elliptical hole on the top, the side has two diagonal arc openings, and the small internal guide goes through these two arc openings and is assembled with the large external guide in a cross way, of which the rectangular slot on the crooked end is placed on the raised pin of the second sector gear, and the other two rectangular slots are placed on the two remaining diagonal pins on the upper carriage.

5. The characteristics of steering structure of toy plane according to the claim 4: Said small internal guide goes through two arc openings and is assembled with the large external guide in a cross way by 45°, and the movement closed angle of the two is 90°.

6. The characteristics of steering structure of toy plane according to the claim 1: Said elliptical shaft has the square upper end and has the groove for facilitating the elliptical shaft to adjust the rotating angle of lower propeller, the middle part is in column shape, the lower end is elliptical, the lower part is positioned in the hole between arc-back bosses of small internal guide, and the middle part is positioned in the elliptical hole of large external guide; rectangle hole with rounded angles, elliptical hole and elliptical shaft are on the joint axis, and the upper end of elliptical shaft is fixed on the mounting structure of lower propeller.

7. Small infrared four-channel remote-control plane is composed of nose covering, landing gears, propeller carriage, tail rod, empennage, upper and lower propeller units, drive mechanism for upper and lower propellers installed on the propeller carriage, and control system for controlling motor running, and characterised in that: It also contains the steering structure, and said steering structure contains small internal guide, large external guide, elliptical shaft, and sector gear; the small internal guide has the rectangle hole with rounded angles and the arc-back bosses, and the small internal guide contacts with the elliptical shaft along the second and fourth quadrants under the driving of sector gear; the large external guide has the elliptical hole, and the large external guide contacts with the elliptical shaft along the first and third quadrants under the driving of sector gear.
